(19) United States
(12) Patent Application Publication
(10) Pub. No.: US 2016/0305280 A1
(43) Pub. Date: Oct. 20, 2016

(54) STEAM POWER PLANT WITH A LIQUID-COOLED GENERATOR

(71) Applicant: SIEMENS AKTIENGESELLSCHAFT, Munich (DE)

(72) Inventors: Esteban Grau Sorarrain, Düsseldorf (DE); Christian Jäkel, Duisburg (DE); Mario Koebe, Mülheim an der Ruhr (DE); Matthias Kowalski, Mülheim an der Ruhr (DE); Christoph Lehmann, Neukirchen-Vluyn (DE); Andrey Mashkin, Köln (DE); Olga Plotnikova, Wuppertal (DE); Carolin Schild, Mülheim an der Ruhr (DE)

(73) Assignee: Siemens Aktiengesellschaft, Munich (DE)

(21) Appl. No.: 15/033,216

(22) PCT Filed: Sep. 18, 2014
(86) PCT No.: PCT/EP2014/069868

§ 371 Date: Apr. 29, 2016

(30) Foreign Application Priority Data
Nov. 5, 2013 (EP) 13191597.7

(51) Int. Cl. F01D 25/12; F01K 11/02; F01D 15/10; F01K 7/16

(52) U.S. Cl. CPC F01D 25/12; F01K 7/16; F01K 11/02; F01D 15/10; F05D 2220/31; F05D 2260/606

(57) ABSTRACT

A steam power plant with a liquid/steam circuit includes a steam generator for converting a liquid into steam, a steam turbine and a condenser for converting the steam into the liquid, a generator and a liquid cooling system for the generator, wherein the liquid cooling system has a connection to the liquid/steam circuit via a bypass-like path of flow through which the liquid from the liquid/steam circuit can be branched out to the liquid cooling system and can be led back from the liquid cooling system to the liquid/steam circuit.

### CROSS REFERENCE TO RELATED APPLICATIONS

This application is the US National Stage of International Application No. PCT/EP2014/069868 filed Sep. 18, 2014, and claims the benefit thereof. The International Application claims the benefit of European Application No. EP13191597 filed Nov. 5, 2013. All of the applications are incorporated by reference herein in their entirety.

### FIELD OF INVENTION

The invention relates to a steam power plant with a liquid-cooled generator.

### BACKGROUND OF INVENTION

In a steam power plant for generating electrical power, a fluid, in particular water, is circulated in a liquid/steam circuit. The liquid/steam circuit has a boiler, a steam turbine and a condenser, wherein in the boiler liquid water is converted into steam. The steam is then expanded in the steam turbine, with the steam turbine driving an electric generator of the steam power plant. Here, the term steam turbine is used as a synonym for a turbine installation which usually has multiple turbines, wherein the first turbine, second turbine and so on are labelled, according to the drop in the pressure of the steam, as high-, intermediate- and low-pressure turbine. After leaving the steam turbine, the steam is condensed in the condenser; the resulting water is collected in a condensate collection container and fed back to the boiler. In that context, the fluid flows through pipes between the individual components of the liquid/steam circuit.

Steam power plants having water-cooled generators can have, in addition to the above-described liquid/steam circuit, multiple separate circuits for circulating a fluid, in particular a liquid and most particularly water. In that context, a cooling liquid circuit in the generator serves to provide cooling liquid at low temperature, to transfer heat in a cooler and to remove the cooling liquid. In addition to entirely water-cooled generators, gas-cooled generators also have a separate water circuit for cooling. For operation of the liquid circuit for cooling the generator, it is necessary to provide cooling liquid and energy externally, thus reducing the efficiency of the steam power plant.

US 2006/0185366 A1 discloses a thermal power plant. EP 2 518 283 A2 describes an expansion system.

On the path from the condenser to the boiler, the temperature of the water, or of the liquid, is raised continuously by means of preheaters. That section of the liquid/steam circuit having the preheaters is also termed the preheating section. An advantage of the preheating is that it saves energy and thus improves the efficiency as it is not necessary to heat too-cold water in the boiler. In addition, when the boiler is fed with hot water, the material of the boiler is not subjected to large temperature changes. For preheating the liquid, use is made for example of steam energy by bleeding steam from the steam turbine, in particular from the intermediate- and/or low-pressure turbine and condensing this steam in corresponding heat exchangers. However, the steam extraction reduces the performance of the power plant since less steam is available to drive the turbine.

### SUMMARY OF INVENTION

The invention has an object of further raising the efficiency of a steam power plant.

This object is achieved with the features of the independent claim. Additional embodiments thereof are indicated in the further patent claims.

The steam power plant according to the invention has a liquid/steam circuit with a boiler for converting a liquid into steam, a steam turbine and a condenser for converting the steam into the liquid, a generator and a liquid cooling system for the generator, wherein the liquid cooling system is connected to the liquid/steam circuit via a bypass flow path through which the liquid can be made to diverge from the liquid/steam circuit such that it flows to the liquid cooling system and from the liquid cooling system back to the liquid/steam circuit.

The liquid is in particular understood to be water. In other words, part of the water in the liquid/steam circuit is split off and is used for direct cooling of the generator, this being understood in particular as cooling of the static parts of the generator and especially the generator stator bars. From the generator, it is pumped back into the circuit, at a suitable point in the preheating section. It will be known to a person skilled in the art that the water must be suitably treated in order to protect the generator from corrosion.

Advantageously, the steam power plant according to the invention also has, in the liquid/steam circuit, one or more preheaters in which the liquid is preheated, a superheater in which the steam produced is superheated prior to entry into the high-pressure turbine, one or more intermediate heaters in which the partially expanded steam is once more superheated prior to entry into the intermediate- and/or low-pressure turbine, and upstream of the boiler at least one feed liquid pump which raises the pressure of the liquid prior to entry into the boiler. The steam power plant according to the invention also advantageously has, in the liquid/steam circuit, a degasser for separating and removing non-condensable gases such as nitrogen, carbon dioxide and oxygen from the condensate.

The invention is advantageous because the bypass flow path obviates the need for a cooling water circuit, to be operated separately, for cooling the generator. Another advantage of the invention is that the heat taken up by the water during cooling of the generator can be used for preheating the water prior to entry into the boiler. Thus, preheating can be performed using an energy source whose heat energy would otherwise be discharged, unused, to the environment as waste heat. Thus, preheating does not require the usual quantity of steam which must be bled from the steam turbine. Hence, more steam is available for energy production. In other words, using the waste heat of the generator to raise the temperature of the water prior to the boiler saves energy in the liquid/steam circuit, saves material and improves the overall efficiency of the power plant.

### BRIEF DESCRIPTION OF THE DRAWINGS

The invention will be explained in more detail below, with reference to the appended schematic drawing. In the drawing:

FIG. 1 shows a schematic representation of a steam power plant having a liquid/steam circuit and a generator, wherein the liquid/steam circuit is connected to the cooling system for the generator via a bypass flow path through which liquid water can be made to flow.

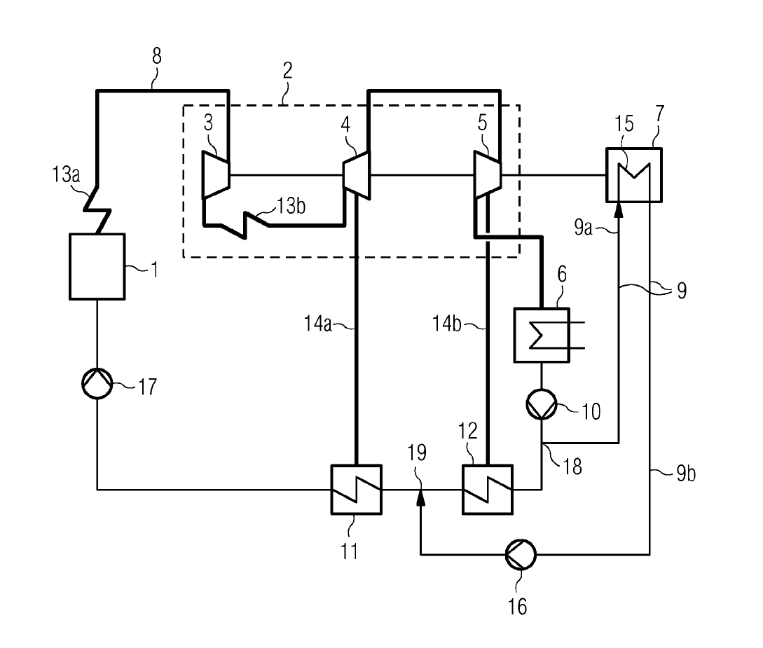

### DETAILED DESCRIPTION OF INVENTION

In that context, the bypass flow path 9 provides liquid for cooling the generator 7, wherein water from the liquid/steam circuit 8 can be used for cooling. The heat taken up by the water during cooling of the generator 7 is used for preheating the water prior to entry into the boiler 1. Hence, as a result of the supply of heat thus achieved, accordingly less steam need be bled from the intermediate-pressure turbine 4 and/or the low-pressure turbine 5 of the steam turbine 2 and fed to the preheater 11 and/or the preheater 12 via the steam lines 14.

It is advantageous if the bypass flow path 9 has a divergent liquid line 9a which is arranged downstream of the condenser 6 and upstream of the boiler 1 of the liquid/steam circuit 8, and via which the liquid from the liquid/steam circuit 8 can be made to flow to the liquid cooling system 15 of the generator. In other words, the divergent part 9a of the bypass flow path has a divergence point 18, from the liquid/steam circuit 8, arranged downstream of the condenser 6 and upstream of the boiler 1.

Advantageously, the divergent liquid line 9a is arranged such that it diverges upstream of the preheaters 11, 12. A valve can be arranged at the divergence point 18. This can be a control valve, in order to control the mass flow of the water, and/or a check valve, in order to prevent the water provided for cooling from flowing back into the liquid/steam circuit 8. It is also possible for multiple valves to be arranged both at the divergence point 18 and in the liquid line 9a.

It is also advantageous if the liquid/steam circuit 8 has, downstream of the condenser 6 and upstream of the divergence point 18 of the bypass flow path, at least one condensate pump 10. Arranging the condensate pump 10 at this location is advantageous because this lends the condensate, or the liquid water, sufficient flow strength to flow in sufficient quantity into the bypass flow path 9.

The bypass flow path 9 advantageously has a part, also termed convergent liquid line 9b, which leads back to the liquid/steam circuit 8 and via which the liquid from the liquid cooling system 15 can be transported back to the liquid/steam circuit 8. In that context, the convergent liquid line 9b of the bypass flow path 9 has a convergence point 19, with the liquid/steam circuit 8, arranged downstream of the divergence point 18 of the bypass flow path and upstream of the boiler 1. It is advantageous if convergent connection between the bypass flow path 9 and the liquid/steam circuit 8 is arranged upstream of the preheaters 11 and/or 12, since it is thus possible to detect the temperature of the water flow and thus to determine to what extent it is necessary to further heat it using steam from the steam turbine 2.

However, the convergent liquid line 9b can also connect to the liquid/steam circuit 8 at another suitable point on the preheating section, for example between the preheaters 11 and 12, or also between the preheaters and the feed liquid pump 17.

The bypass flow path 9 advantageously has at least one bypass pump 16. This embodiment is advantageous because the liquid water then has the required flow strength to flow in sufficient quantity into the liquid/steam circuit 8. For that reason, it is particularly advantageous if the at least one bypass pump 16 is arranged between the generator cooling system 15 and the liquid/steam circuit 8. It is also advantageous if the at least one pump 10 is arranged downstream between the divergence point 18 from the liquid/steam circuit and the generator cooling system 15. It is also possible for multiple bypass pumps 16 to be arranged in the bypass flow path 9.

Advantageously, a valve is arranged at the convergence point 19 between the convergent connection 9b of the bypass flow path and the liquid/steam circuit 8. This can be a control valve, in order to control the flow of the water, and/or a check valve, in order to prevent the water from flowing back into the bypass flow path 9. It is also possible for valves to be arranged within the convergent liquid line 9b.

It is moreover advantageous if the bypass flow path 9 has a device for de-mineralizing the liquid water. The de-mineralizing device is advantageous since dissolved minerals can enhance or permit the electrical conductivity of the water. This can have a negative effect on the electricity-generating generator. The de-mineralizing device is also advantageous since de-mineralized water is less corrosive and thus corrosion of the material can be minimized. In order, in particular, to minimize the electrical conductivity of the water, relatively thorough de-mineralization of the water should be carried out prior to entry into the generator or the generator region with corresponding liquid lines. In this context, it is particularly advantageous and thus advantageous if the device for de-mineralizing the liquid water is arranged upstream of the generator 7, that is to say in the liquid line 9a. It is in principle also possible, however, for the de-mineralizing device to be arranged in the liquid/steam circuit 8. In order to limit the conductivity from the very start, however, it is generally advantageous to use desalinated water in the liquid/steam circuit 8.

As mentioned in the introduction, gas-cooled generators are also cooled using a separate water circuit. Hence, the described invention can also in principle be realized and used with gas-cooled generators.

Although the invention has been described and illustrated in greater detail by means of the preferred exemplary embodiment, the invention is not limited by the disclosed example. Other variants can be derived herefrom by a person skilled in the art without departing from the protective scope of the invention.

1. A steam power plant, having
a liquid/steam circuit with a boiler for converting a liquid into steam,
a steam turbine and a condenser for converting the steam into the liquid,
a generator and a liquid cooling system for the generator,
wherein the liquid cooling system is connected to the liquid/steam circuit via a bypass flow path through which the liquid can be made to diverge from the liquid/steam circuit such that it flows to the liquid cooling system and from the liquid cooling system back to the liquid/steam circuit,
wherein the bypass flow path has at least one bypass pump,
wherein the at least one bypass pump is arranged downstream of the generator cooling system and upstream of the convergence point of the bypass flow path and the liquid/steam circuit,
wherein the bypass flow path has a device for de-mineralizing the liquid, which device is arranged upstream of the generator.

2. The steam power plant as claimed in claim 1,
wherein the divergent part of the bypass flow path has a divergence point, from the liquid/steam circuit, arranged downstream of the condenser and upstream of the boiler.

3. The steam power plant as claimed in claim 2,
wherein the liquid/steam circuit has at least one condensate pump arranged downstream of the condenser and upstream of the divergence point, from the liquid/steam circuit, of the bypass flow path.

4. The steam power plant as claimed in claim 2,
wherein the convergent part of the bypass flow path has a convergence point, with the liquid/steam circuit, arranged downstream of the divergence point of the bypass flow path and upstream of the boiler.
